(19) United States
(12) Patent Application Publication
(10) Pub. No.: US 2006/0206810 A1
(43) Pub. Date: Sep. 14, 2006

(54) Document managing apparatus

(75) Inventors: Noriyuki Komamura, Mishima-shi (JP); Nobuhiro Shimogori, Kawasaki-shi (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/077,828

(22) Filed: Mar. 10, 2005

(51) Int. Cl. G06F 17/24; G06F 17/21

(52) U.S. Cl. 715/526

(57) ABSTRACT

A document managing apparatus manages document managing information on the plural managed documents while managing file managing information on a first file of data which constitutes a document which is a managing target. In the apparatus, transfer information is stored in relation to the managed document of the document managing information storage unit, the transfer information indicating whether the managed file is transferred to a mobile equipment through the interface according to a condition previously set. The interface is connected to the mobile equipment while the data can be transferred. When the apparatus receives a direction from an operation unit, the apparatus selects only the document transferred to the mobile equipment based on the stored transfer information. The apparatus displays an image of the selected document on a display unit in the particular order according to the direction from the operation unit.

### BACKGROUND OF THE INVENTION

1. Field of the Invention

The present invention relates to an apparatus and program for managing document which manage a data file constituting a document.

2. Description of the Related Art

Jpn. Pat. Appln. KOKAI Publication No. H5-54081 discloses a file data searching apparatus in which electronic filing is performed and file data is stored. In the file data searching apparatus, the file data search is performed as follows: during the search, the pieces of file data are rearranged in the order in which the file data having the latest final search date is put on the leading end, and the search is performed in the rearranged order. Then, the pieces of file data are displayed in the searched order. An operator stops the search at a stage in which the necessary file data is displayed. Therefore, the search can be stopped at the time when the objective image is displayed.

In mobile equipment such as a cellular phone and a personal digital assistant (PDA), when the document can be searched like the file data searching apparatus, it is very convenient because a user can also search the document on the road. It is possible that the file is transferred from the file data searching apparatus to the mobile equipment, and that a function of searching the document is placed on the mobile equipment.

However, usually storage capacity is restricted in the mobile equipment such as the cellular phone and PDA, so that operation of the mobile equipment becomes worse when the file having the same capacity as for the file data searching apparatus is transferred to the mobile equipment. Therefore, the user cannot comfortably search the document.

In order to avoid such problems, it is thought that only a part of the file data is transferred from the file data searching apparatus to the mobile equipment. Therefore, the operation of the mobile equipment becomes smooth. However, when the user searches the same document by both the file data searching apparatus and the mobile equipment, because only a part of the file is transferred, sometimes the search result becomes different. Accordingly, there is generated a problem that it becomes difficult for the user to find the target document.

### BRIEF SUMMARY OF THE INVENTION

An object of the invention is to provide a document managing apparatus and document managing program which can search the document while limiting the document to the document transferred to mobile equipment.

According to an aspect of the present invention, there is provided a document managing apparatus comprising: a display unit; an operation unit; an interface which is connected to mobile equipment while data can be transferred; a file managing information storage unit which stores file managing information on a file of data which constitutes a document, the document being a managing target; a document managing information storage unit which stores document managing information on a plurality of documents, the plurality of documents being stored in the file managing information storage unit; a transfer information storage unit which stores transfer information in relation to the document stored in the document managing information storage unit, the transfer information indicating whether the file stored in the file managing information storage unit is transferred to the mobile equipment through the interface according to a condition previously set; a selection unit which selects only the document transferred to the mobile equipment based on the transfer information stored in the transfer information storage unit when a direction is received from the operation unit; and a document display unit which displays a document image on the display unit in the particular order according to a direction from the operation unit, the document image being selected by the selection unit.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing schematic configuration of a document managing system and a document managing apparatus according to an embodiment of the invention;

FIG. 2 is a diagram showing schematic configuration of a mobile equipment according to the embodiment;

FIG. 3A shows a mouse according to the embodiment;

FIG. 3B shows a display example of a document searching screen according to the embodiment;

FIG. 4 shows a relationship between a document managed by the document managing apparatus according to the embodiment and an image displayed in an image display area;

FIG. 5 is a first file managing table according to the embodiment;

FIG. 6 is a second file managing table according to the embodiment;

FIG. 7 is a document managing table according to the embodiment;

FIG. 8 is another document managing table according to the embodiment;

FIG. 9 is still another document managing table according to the embodiment;

FIG. 10 is a color managing table according to the embodiment;

FIG. 11 is a flowchart for explaining a process of entering document managing information according to the embodiment;

FIG. 12 is a flowchart for explaining an image generating process according to the embodiment;

FIG. 13 is a flowchart for explaining a process of displaying a document searching screen according to the embodiment;

FIG. 14 is a flowchart for explaining a document map generating process according to the embodiment;

FIG. 15 is a part of a flowchart for explaining a document searching process according to the embodiment;

FIG. 16 is another part of the flowchart for explaining the document searching process according to the embodiment;

FIG. 17 is still another part of the flowchart for explaining the document searching process according to the embodiment;

FIG. 18 is a flowchart for explaining a document transferring process according to the embodiment;

FIG. 19 is a flowchart for explaining a document synchronizing process according to the embodiment;

FIG. 20 is a flowchart for explaining a mobile filtering process according to the embodiment; and

FIG. 21 shows an example of the document searching screen according to the embodiment when the document searching is performed according to the mobile filtering process.

### DETAILED DESCRIPTION OF THE INVENTION

Referring to the drawings, an embodiment of the invention will be described in detail.

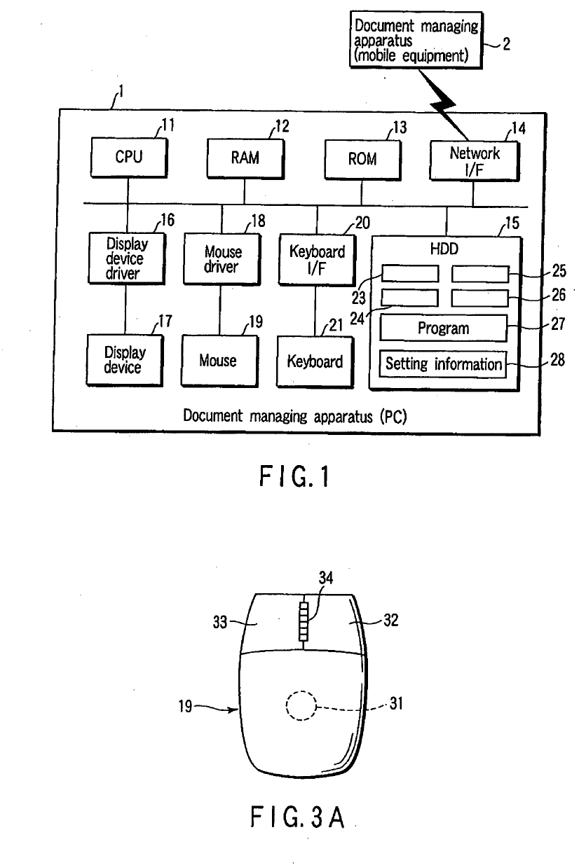

FIG. 1 is a block diagram showing a schematic configuration of a document managing apparatus 1 according to an embodiment of the invention.

For example, the document managing apparatus 1 is a PC. The document managing apparatus 1 is connected to mobile equipment 2 which is the document managing apparatus. The document managing apparatus 1 can also be connected to an image input/output apparatus (not shown). Examples of the image input/output apparatus include a scanner, a digital multi-function peripheral (MFP) provided with the scanner, a digital camera, and a computer on a network (for example, a WWW server). Because the configuration in which the image input/output apparatus is connected is similar to that of the conventional technology, the description will not be repeated.

As shown in FIG. 1, the document managing apparatus 1 includes a CPU 11, a RAM 12, a ROM 13, a network interface (I/F) 14, a hard disk drive (HDD) 15, a display device driver 16, a display device 17, a mouse driver 18, a mouse 19, a keyboard interface (I/F) 20, and a keyboard 21.

The CPU 11 controls the whole of the document managing apparatus 1. The CPU 11 realizes various functions by executing control programs stored in the ROM 13 and application programs stored in the HDD 15. The RAM 12 is a memory in which working data and the like are temporarily stored. The ROM 13 is a non-volatile memory in which a basic program to operate the document managing apparatus (PC) 1 and the like are previously stored.

The network interface 14 outputs the image data and a predetermined command to the mobile equipment 2. The network interface 14 functions as the interface which outputs the data and the command for enabling communication to the mobile equipment 2. Specifically, examples of the network interface 14 include a wireless communication interface to perform the wireless communication with the mobile equipment, a LAN interface connected to LAN, and a USB interface. In the embodiment, the network interface 14 includes a cradle which is connected to the communication interface and used for the communication. In this case, the communication can be performed by connecting the mobile equipment 2 to the cradle.

The HDD 15 is a storage device including a magnetic disk. Various kinds of data are stored in the HDD 15 in a file format. The data which constitute the document which is of a managing target of the document managing apparatus 1 is stored in the HDD 15 in the file format.

A first file managing table 23, a second file managing table 24, a document managing table 25, a color managing table 26, and the like are provided as a data table in the HDD 15.

The first file managing table 23 and the second file managing table 24 are tables in which managing information (file managing information) on the data file which constitutes the document of the managing target is stored. The document managing table 25 is the table in which managing information (document managing information) and related information on the document of the managing target are stored. The color managing table 26 is the table in which information (color managing information) on the color related to the document of the managing target is stored. The data tables 23 to 26 will de described in detail later.

At least an application program (document managing program) 27 and setting information 28 are stored in the HDD 15. The application program 27 causes the PC to function as the document managing apparatus 1.

The document managing program 27 includes programs which cause the PC to execute various processes such as a document managing information entering process, an image generating process, a document searching screen displaying process, a document map generating process, and a document searching process, a document transferring process, and a mobile filtering process. These processes will be described later. By performing the document managing program 27, the PC realizes various functions such as a document managing information entering function, an image generating function, a document searching screen displaying function, a document map generating function, a document searching function, a document transferring function and a mobile filtering function.

The display device driver 16 includes a drive circuit which controls display contents of the display device 17. The display device driver 16 functions as the interface which outputs signals of the image displayed on the display device 17 to the display device 17. The mouse driver 18 includes a circuit which detects information inputted to the mouse 19. The mouse driver 18 detects motion of the mouse 19, input to a button provided in the mouse 19, a rotating amount of a wheel provided in the mouse 19, and the like. The mouse driver 18 informs the CPU 11 of the signals which indicate the motion of the mouse 19, the input to the button provided in the mouse 19, the rotating amount of the wheel provided in the mouse 19, and the like.

The keyboard interface 20 detects the information inputted to the keyboard 21 and informs the CPU 11 of the information. The keyboard 21 includes plural keys such as characters, numerals, and symbols. The keyboard interface 20 detects the input to each key of the keyboard 21, and the keyboard interface 20 informs the CPU 11 of the signals which indicate the inputted key.

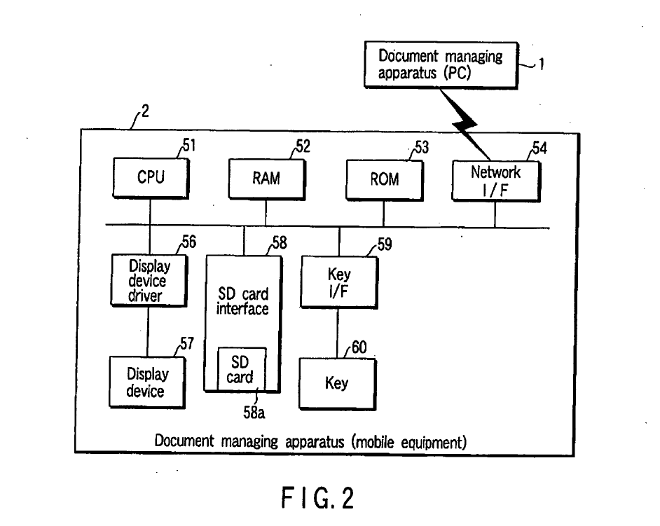

FIG. 2 is a block diagram showing a schematic configuration of the mobile equipment 2 which is of the document managing apparatus according to the embodiment of the invention.

As described above, the mobile equipment 2 can be connected to the document managing apparatus 1. Examples of the mobile equipment 2 include the cellular phone and the PDA.

As shown in FIG. 2, the mobile equipment 2 includes a CPU 51, a RAM 52, a ROM 53, a network interface (I/F) 54, a display device driver 56, a display device 57, an SD card interface 58, a key (I/F) 59, and a key 60.

The CPU 51 controls the whole of the mobile equipment 2. The CPU 51 realizes various functions by executing control programs stored in the ROM 53. The RAM 52 is a memory in which working data and the like are temporarily stored. The ROM 53 is a non-volatile memory in which a basic program for operating the mobile equipment (PC) and the like are previously stored.

The network interface 54 receives the data and the command from at least the document managing apparatus 1. The network interface 54 can receive the data and the command when the mobile equipment 2 is arranged in the cradle connected to the document managing apparatus 1.

The display device driver 56 includes a drive circuit which controls display contents of the display device 57. The display device driver 56 functions as the interface which outputs signals of the image, displayed on the display device 57, to the display device 57. A display area in which at least the later-mentioned document searching screen is displayed is provided in the display device 57.

The SD card interface 58 reads the data from an SD card 58a and writes the data in the SD card 58a. In FIG. 2, the SD card 58a is stored. Control programs which perform the later-mentioned document searching process and document synchronizing process are stored in the SD card 58a. The CPU 51 executes the control program, stored in the SD card 58a, to realize the document searching function and the document synchronizing function. The data file which constitutes the document transferred from the document managing apparatus 1 and the data of the document managing information on the transferred document are stored in the SD card 58a.

The key interface 59 detects information inputted to the key 60 and informs the CPU 51 of the inputted information. The key includes plural keys such as an arrow key, characters, numerals, and symbols. Input to each key in the key 60 is detected by the key interface 59, and the CPU 51 is informed of the input as the signal which indicates the inputted key.

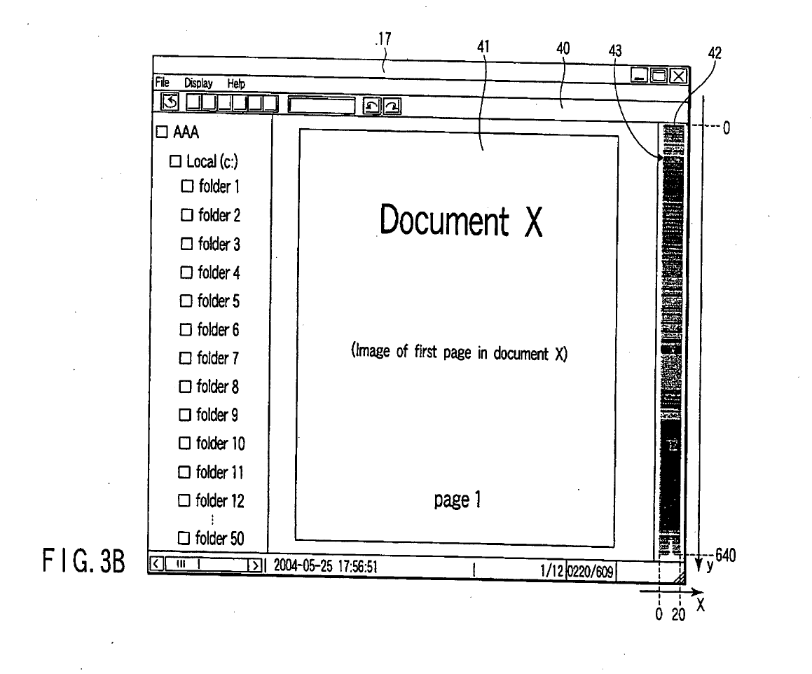

Thus, the hardware configurations of the document managing apparatus 1 and the mobile equipment 2 are described. Then, the mouse 19 of the document managing apparatus 1 will be described referring to FIG. 3A, and a document searching screen in searching the document will be described referring to FIG. 3B.

FIG. 3A shows a configuration of the mouse 19.

As shown in FIG. 3A, the mouse 19 has a motion detecting mechanism 31, a right button 32, a left button 33, and a wheel 34. The mouse 19 is operated while placed on a plane as shown in FIG. 3A. The mouse 19 shown in FIG. 3A is held by a user's hand. The user moves the mouse 19 on the plane as shown in FIG. 3A, and the user operates the right button 32, the left button 33, and the wheel 34 as necessary.

The motion detecting mechanism 31 converts the motion of the mouse 19 on the plane into the signals. For example, the motion detecting mechanism 31 includes a sphere which is rotated according to the motion of the mouse 19 and a mechanism which converts the motion of the sphere into the signals. It is also possible that the motion detecting mechanism 31 includes an optical sensor which detects the motion of the mouse 19 on the plane and the mechanism which converts the mouse motion detected by the optical sensor into the signals. The motion detecting mechanism 31 is provided on the side which is in contact with the plane as shown in FIG. 3A. When the user moves the mouse 19 with the mouse held in the state shown in FIG. 3A, the motion detecting mechanism 31 detects the motion of the mouse on the plane. The signals which indicate the mouse motion detected by the motion detecting mechanism 31 is outputted to the mouse driver 18.

The right button 32 is one which is provided on the right side of a main body of the mouse 19 in the state shown in FIG. 3A. When the user holds the main body of the mouse 19 shown in FIG. 3A by a right hand, the user operates the right button 32 by a forefinger or a middle finger of the user. The left button 33 is one which is provided on the left side of the main body of the mouse 19 in the state shown in FIG. 3A. When the user holds the main body of the mouse 19 shown in FIG. 3A by the right hand, the user operates the left button 33 by the middle finger or a third finger of the user.

The wheel 34 is a rotating member which is provided near the central portion of the mouse 19 in the state shown in FIG. 3A. In FIG. 3A, the wheel 34 is provided between the right button 32 and the left button 33. The user operates the wheel 34 by the forefinger, the middle finger, or the third finger of the user while holding the main body of the mouse 19 in the state shown in FIG. 3A.

The wheel 34 is placed so as to be rotated only in a predetermined direction. In FIG. 3A, the wheel 34 is rotated in the direction from the front side to the back side (from the lower side to the upper side in FIG. 3A) and in the reverse direction (from the lower side to the upper side in FIG. 3A). In the following description, with reference to the rotating direction of the wheel 34, the rotating direction in which the wheel 34 is rotated from the front side to the back side (from the lower side to the upper side in FIG. 3A) shall mean a normal direction, and the rotating direction in which the wheel 34 is rotated from the back side to the front side (from the lower side to the upper side in FIG. 3A) shall mean the reverse direction.

It is possible that the wheel 34 functions as the button. In this case, particular input is performed by pressing the wheel 34 down. Further, it is possible that the particular input is performed by pushing the wheel 34 down to the right or the left.

Then, the document displaying screen (document searching screen) managed by the document managing apparatus 1 will be described.

FIG. 3B shows a document searching screen (document displaying screen) 40 displayed on the display device 17 on the document managing apparatus 1.

In the document managing apparatus 1, the document searching screen 40 is displayed on a display window of the display device 17. In the document searching screen 40, as shown in FIG. 3B, the image of each page which constitutes the document managed by the document managing apparatus 1 is displayed in unit of one page according to the user's operation. The user searches the desired document by referring to the image displayed on the document searching screen 40 shown in FIG. 3B.

In FIG. 3B, in addition to tool bars including various operation keys such as a mobile filter key 17a which is performed later-mentioned the mobile filtering process, an image display area 41, a document map (search bar) 42, an arrow 43, and the like are displayed on the document searching screen 40.

The image display area 41 is located in the substantial center of the display window as the document searching screen 40 displayed on the display device 17. The images of one or more pages which constitute the document are displayed in unit of page in the image display area 41 according to the user's operation.

The document map 42 is displayed on a right end area of the document searching screen 40. In the document map 42, a bar (line) which indicates each document managed by the document managing apparatus 1 is displayed while the documents are stacked on one another in the time-series order. The document map 42 shows the state in which the documents managed by the document managing apparatus 1 are stacked. In the document map 42 shown in FIG. 3B, the uppermost bar indicates the document having the latest document time (newest document), and the lowermost bar indicates the document having the earliest document time (oldest document). Namely, in the document map 42 shown in FIG. 3B, the stacked bar indicates the newer document when the bar is located at upper position, and the stacked bar indicates the older document when the bar is located at lower position.

The arrow 43 is displayed in the area adjacent to the document map 42 in the document searching screen 40. The arrow 43 indicates the position of the bar on the document map 42. The bar indicates the document to which the image, displayed in the image display area 41, belongs. Namely, the arrow 43 indicates the position of the bar which shows the displayed document on the document map 42.

In the document map 42, the bar corresponding to each document is displayed by a color corresponding to each document. The color of each bar corresponding to each document displayed on the document map 42 is set, for example, in each folder in which the data file constituting the document is stored. In this case, the document in which the data is stored in the same folder is displayed in the same color, and the document in which the data is stored in the different folders is displayed in the different color. Therefore, the user can intuitively recognize the folder in which each document is stored by the color displayed in the document map 42. It is possible that the color of the bar corresponding to each document displayed in the document map 42 is set in each file extension of the document or in each application for opening the document.

Then, the change of the image displayed in the image display area 41 of the document searching screen 40 will be described.

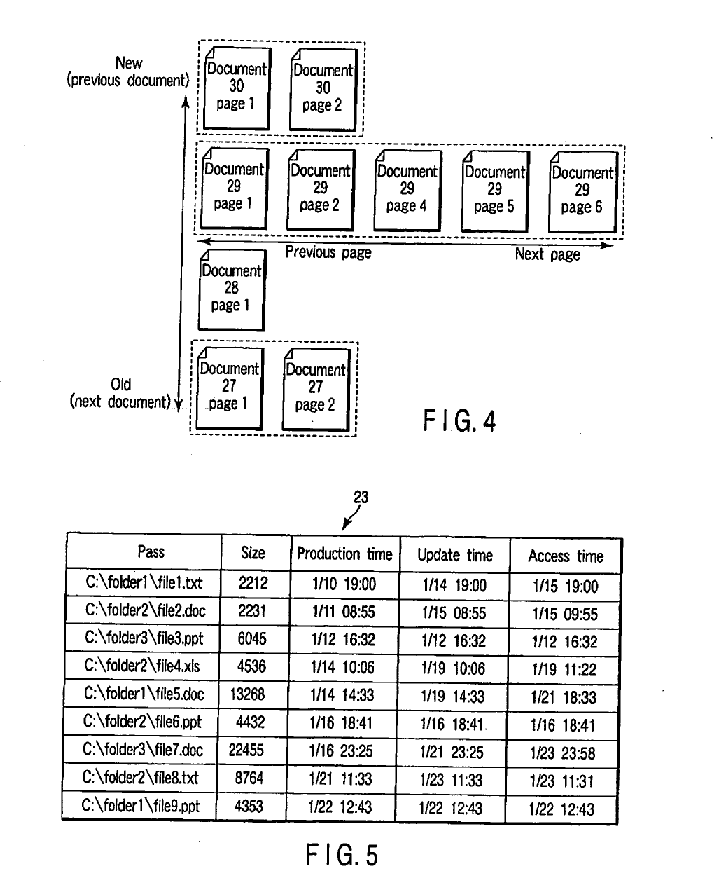

FIG. 4 shows a relationship between a document managed by the document managing apparatus 1 and the image displayed in the image display area 41.

Each document managed by the document managing apparatus 1 includes one or plural pages as shown in FIG. 4. The image displayed in the image display area 41 of the document searching screen 40 shown in FIG. 3 is configured to be changed in response to the input to the mouse 19 or the keyboard 21. The change of the image displayed in the image display area 41 includes the change of the document and the change of the page.

In the document managing apparatus 1, as shown in FIG. 4, the plural documents are managed in the time-series order based on the time when the document is produced or the time when the document is updated. The order of the documents is reflected in the display order of the bars corresponding to the documents which are displayed in the document map 42 while stacked. Accordingly, as shown in FIG. 3, the bars corresponding to the documents are displayed while stacked in the time-series order.

In the document managing apparatus 1, as shown in FIG. 4, the plural pages in each document are managed in the order of the page.

In the document managing apparatus 1, the document displayed in the document searching screen 40 is changed according to the operation of the mouse 19 or the keyboard 21 in the longitudinal direction (vertical direction in FIG. 3). Further, in the document managing apparatus 1, the page displayed in the document searching screen 40 is changed according to the operation of the mouse 19 or the keyboard 21 in the crosswise direction (horizontal direction in FIG. 3).

When the user performs the operation in the longitudinal direction with the mouse 19 or the keyboard 21, the document managing apparatus 1 changes the documents displayed in the image display area 41 of the document searching screen 40. As a result, the representative image (for example, the first page image in the document) of the document changed according to the user's operation in the longitudinal direction is displayed in the image display area 41 of the document searching screen 40. When the user performs the operation in the crosswise direction with the mouse 19 or the keyboard 21, the document managing apparatus 1 changes the pages displayed in the image display area 41 of the document searching screen 40. As a result, the image of the page changed according to the user's operation in the crosswise direction is displayed in the image display area 41 of the document searching screen 40.

The change of the image displayed in the image display area 41 of the document searching screen 40 in unit of document will be described below.

The user directs to change the document using an input device such as the mouse 19 and the keyboard 21. In this case, as described above, the document as the image displayed in the image display area 41 should be changed according to the operation in the longitudinal direction (vertical direction). For example, the document is changed according to the input to upward and downward cursor keys (upward key and downward key) of the keyboard 21 or the operation in the longitudinal direction by a pointing device such as the mouse 19. In the embodiment, the document is also changed according to the rotation of the wheel 34 of the mouse 19. The process of changing the document by the wheel 34 of the mouse 19 will be described in detail later.

When the document is changed by the above operation, the first page image is displayed as the representative image of the document in the image display area 41 of the document searching screen 40. Namely, the first page image in each document is displayed in the image display area 41 each time the document is changed with the mouse 19 and the keyboard 21. In is possible that the representative image of each document is set at the particular page in the pages of each document.

When the representative image (image of the first page) is changed in the document displayed in the image display area 41, the user directs to change the document using the input device such as the mouse 19 and the keyboard 21. Then, the document managing apparatus 1 changes the first page image of the document displayed in the image display area 41 in the time-series order. At this point, the memo is displayed in the document having the related information. The process of displaying the related information will be described later.

The change of the image displayed in the image display area 41 of the document searching screen 40 in unit of page will be described below.

The user directs to change the page using the input device such as the mouse 19 and the keyboard 21. In this case, as described above, the page as the image displayed in the image display area 41 should be changed according to the operation in the crosswise direction. For example, the page is changed according to the input to rightward and leftward cursor keys (rightward key and leftward key) of the keyboard.

Each time the page is changed by the above operation, the image of each page which constitutes the document is sequentially displayed in the image display area 41 of the document searching screen 40. Namely, when the particular page in the particular document is displayed in the image display area 41, the user directs to change the document to display the first page image of the desired document in the image display area 41. In such a state, when the user directs to change the page using the mouse 19 or the keyboard 21, the document managing apparatus 1 displays the image of each page which constitutes the document in the image display area 41 in the order of the page.

Although the above description is performed for the document managing apparatus 1, even in the display device 57 of the mobile equipment 2, the substantially same document searching screen is displayed and the display is similarly changed. Therefore, the detail description will not be repeated. However, because all the documents stored in the document managing apparatus 1 are not transferred to the mobile equipment 2, a document map in the document searching screen is produced only for the transferred document in the mobile equipment 2. For example, when 100 documents are transferred from the document managing apparatus 1, the document map of the 100 documents is produced. When the documents are changed by the mobile equipment 2, the change is performed by the input with the arrow key provided in the key 60. For example, the document is changed with up and down keys in the arrow key, and the page is changed with right and left keys in the arrow key.

The data tables 23 to 26 which manage the document in the document managing apparatus 1 having the above configuration will be described below.

In the document managing apparatus 1, the data which constitute each document of the managing target is stored in the HDD 15 in the file format. The file of the data which constitutes the document stored in the HDD 15 is managed by the first file managing table 23 and the second file managing table 24. The file of the related information data is stored in a predetermined folder of the HDD 15. The document corresponding to the file stored in the HDD 15 is managed by the document managing table 25. The color of the bar which indicates each document in the document map 42 of the document searching screen 40 is managed by the color managing table 26.

The first file managing table 23 and the second file managing table 24 will be described below.

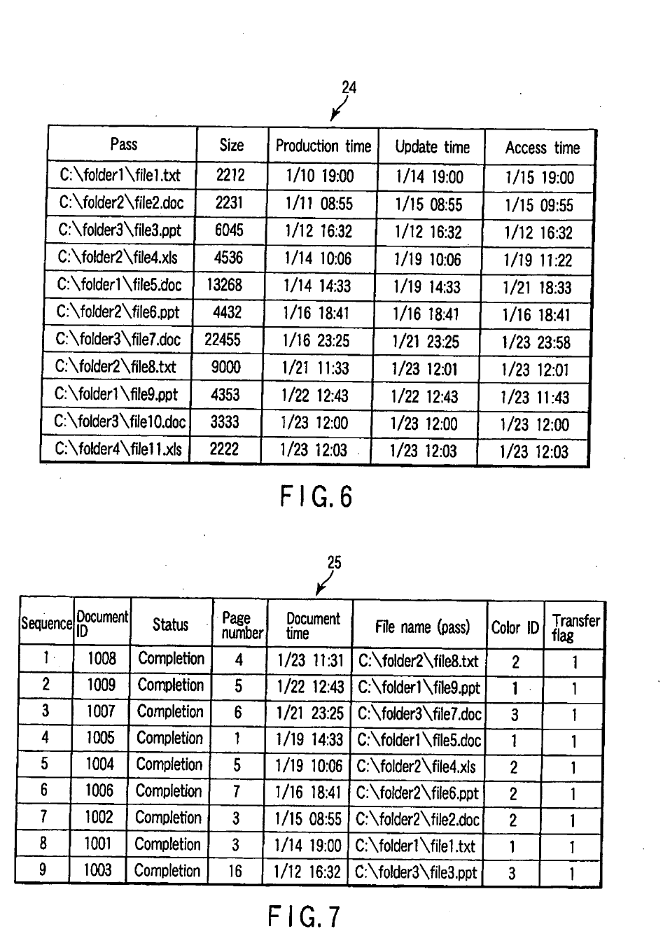

FIG. 5 shows a configuration of the first file managing table 23. FIG. 6 shows a configuration of the second file managing table 24.

The managing information on each file as each document managed by the document managing apparatus 1 is stored in the first file managing table 23 and the second file managing table 24.

As shown in FIGS. 5 and 6, the first file managing table 23 and the second file managing table 24 are configured so that the file managing information such as a pass, a size, a production time, an update time, and an access time is stored in the first file managing table 23 and the second file managing table 24.

The information which indicates a drive name and a folder name, in which the file exists, and the information which indicates a file name of the file are stored as the pass. The data size of the file is stored as the size. The date and time when the file is produced is stored as the production time. The date and time when the file is updated is stored as the update time. The latest date and time when access to the file is performed is stored as the access time.

The managing information of each file at a past point in time is stored in the first file managing table 23. The past point in time shall be the time when the document managing apparatus 1 is started up last time. On the other hand, a list of the current files is shown in the second file managing table 24. Accordingly, the second file managing table 24 is updated at any time according to the update and addition of the file.

For example, when the document managing apparatus 1 is started up, the information of the second file managing table 24 at this point is stored as the first file managing table, and the new second file managing table 24 is produced (updated). The managing information on the newly added file and the updated file is stored in the second file managing table 24. Namely, the difference between the file in the last-time start-up and the file in the present-time start-up is expressed as the difference between the first file managing table 23 and the second file managing table 24. In the embodiment, the update status of the file (new entry or update) is determined by the difference between the first file managing table 23 and the second file managing table 24.

As an example of the new entry of the file, it is assumed that the document managing apparatus 1 obtains the document including the images of the plural pages through the network interface 14. In this case, the data of the document obtained through the network interface 14 is stored as the new entry file in the HDD 15. At this point, a field in which the managing information on the new entry file is stored is added to the second file managing table 24, and the pass, the size, the production time, the update time, the access time, and the like are stored as the managing information of the new entry file. The information stored in the first file managing table 23 is held with no change.

As an example of the file update, it is assumed that the file having the managing information in the second file managing table 24 is updated. In this case, the updated file is stored by overwriting the already-existing file in the HDD 15. In the managing information on the updated file in the second file managing table 24, the size, the update time, the access time, the header information, and the like are updated based on the updated file. The information stored in the first file managing table 23 is also held with no change.

Then, the document managing table 25 will be described.

FIGS. 7, 8, and 9 show a configuration of the document managing table 25.

The document managing table 25 is one which manages the file, managed by the first file managing table 23, as the document. As shown in FIGS. 7, 8, and 9, in the document managing table 25, a sequence, the document ID, a status, the number of pages, a document time, the file name, a color ID, a transfer flag, and the like are stored as the managing information on the document.

The information which indicates the display order of each document is stored as the sequence. As described above, the documents are displayed in the time-series order based on the document time in the document searching screen 40 shown in FIG. 3. Accordingly, in the document managing table 25, the document time manages the sequence of the documents in the order of the time.

The unique ID information given to each document is stored as the document ID. The ID information identifies each document.

The information which indicates the processing status of each document is stored as the status. For example, the information which indicates “update” status or the information which indicates “completion” status is stored as the status. “Completion” means the status in which the update (update or new entry) of the document is completed. “Update” means the status in which the document waits for the update (update or new entry).

The information which indicates the number of pages of the document is stored as the number of pages. The number of pages is confirmed when the status of the document becomes “completion”.

The production time or the update time of each document is stored as the document time. For example, the update time of the file corresponding to the document managed by the first file managing table 23 is stored as the document time.

The information which indicates the file corresponding to the document is stored as the file name. For example, the drive name, the folder name, and the file name with respect to the file corresponding to each document are stored as the file name.

The information which indicates the color to display the information showing each document is stored in the color ID. The color ID means the unique ID information given to each color to identify the color. The information which indicates the actual color corresponding to the color ID is shown by the color managing table 26.

With reference to the transfer flag, a flag, which indicates the file transferred to the mobile equipment 2 connected to the network interface 14 or the file not transferred, is stored. In the embodiment, the transfer flag is set at “1” for the document transferred to the mobile equipment 2, and the transfer flag is set at “0” for the document which is not transferred to the mobile equipment 2.

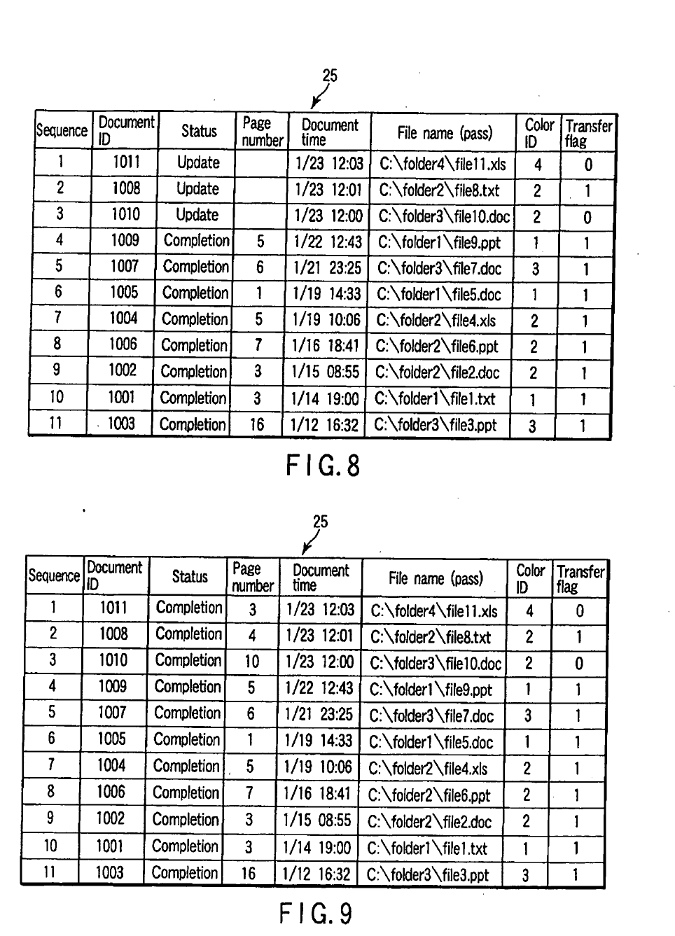

The document managing table 25 is updated by the process of entering the document managing information. For example, nine documents are managed in the document managing table 25 shown in FIG. 7. In such a state, the document having the document ID “1008” is updated, and the document having the document ID “1010” and the document having the document ID “1011” are newly added. In this case, in the later-mentioned process of entering the document managing information, three documents whose statuses are set at “update”, (document ID “1008”, document ID “1010”, and document ID “1011”) are entered in the document managing table 25 shown in FIG. 7. Then, the document managing table 25 shown in FIG. 8 is produced.

The statuses of the three documents of the document ID “1008”, the document ID “1010”, and the document ID “1011” are stored as “update” in the document managing table 25 shown in FIG. 8. As shown in FIG. 8, the later-mentioned image generating process is sequentially performed to the documents in which the status is set at “update” in the document managing table 25. In the document in which the image generating process is completed, the status is updated to “completion”. Accordingly, when the image generating process to the three documents of the document ID “1008”, the document ID “1010”, and the document ID “1011” is completed, the document managing table 25 shown in FIG. 8 is updated to the document managing table 25 shown in FIG. 9.

The number of pages of each document should be confirmed by the number of images generated by the image generating process, which will be described later. Therefore, in the document managing table 25, the number of pages of each document whose status is “update” becomes the blank field as shown in FIG. 8. For the document whose status is changed from “update” to “completion”, as shown in FIG. 9, the number of images generated by the later-mentioned image generating process is stored as the number of pages.

Then, the color managing table 26 will be described.

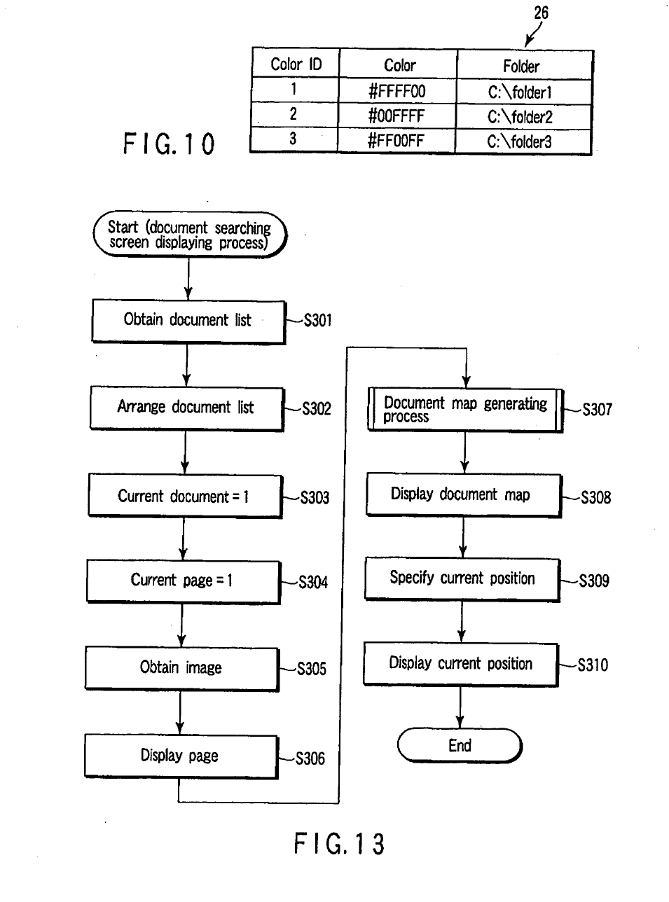

FIG. 10 shows a configuration of the color managing table 26.

The color managing table 26 is one in which the color ID, the color (information which indicates the actual color), and the folder are correlated with one another. In the document managing table 25, as described above, the color corresponding to each document is shown by the color ID. Accordingly, the color corresponding to each document is determined by the color ID of the document managing table 25 and the color of the color managing table 26. The color corresponding to each document shall mean the color of the bar corresponding to each document displayed in the document map 42 of the document searching screen 40. In the embodiment, when the later-mentioned mobile filtering process is performed, the bar of the document which is not transferred to the mobile equipment 2 is set in grey.

As described above, in the embodiment, the color of the bar corresponding to each document displayed in the document map 42 of the document searching screen 40 is set in each folder. Accordingly, as shown in FIG. 10, the color managing table 26 shows the color ID and color which correspond to each folder. When the color of the bar corresponding to each document displayed in the document map 42 is set in each file extension or in each application which opens the document, the color ID and color which correspond to each extension or each application are stored in the color managing table 26.

Then, the process of entering the document managing information in the document managing apparatus 1 will be described.

FIG. 11 is a flowchart for explaining the process of entering the document managing information in the document managing apparatus 1.

When the document managing apparatus 1 is started up, i.e. when the PC as the document managing apparatus 1 starts up the document managing program 27, the CPU 11 reads the first file managing table 23 in the HDD 15 as the file information of the previous time (Step S101). When the first file managing table 23 is read, the CPU 11 reads the second file managing table 24 in the HDD 15 as the current file information (Step S102).

When the first file managing table 23 and the second file managing table 24 are read, the CPU 11 performs a difference file detecting process (Step S103). The difference between the managing information (previous file information) of all the files stored in the first file managing table 23 and the managing information (current file information) of all the files stored in the second file managing table 24 is detected in the difference file detecting process. The information which indicates the difference file detected by the difference file detecting process is temporarily stored in, e.g. the RAM 12.

In the difference file detecting process, the updated file or the newly added file is extracted since the previous file information is produced. In the embodiment, the access time should not be set at the detecting target as the difference file.

It is determined that the file which does not exist in the previous file information but exist in the current file information, i.e. the file which exists only in the second file managing table 24 is the newly added file.

It is determined that the file in which the update time in the current file information differs from the update time in the previous file information, i.e. the file in which the first file managing table 23 differs from the second file managing table 24 in the update time is the updated file.

It is determined that the file which does not exist in the current file information but exist in the previous file information, i.e. the file which exists only in the first file managing table 23 is the deleted file.

For example, in the process of detecting the difference file between the first file managing table 23 shown in FIG. 5 and the second file managing table 24 shown in FIG. 6, three files whose file names are “file8.txt”, “file10.doc”, and “file11.xls” are detected as the difference file.

In this case, the file “file8.txt” whose pass is “C:\folder2\file8.txt” has the different update time. Therefore, it is determined that the file “file8.txt” is the updated file.

The file “file10.doc” whose pass is “C:\folder3\file10.doc” and the file “file11.xls” whose pass is “C:\folder4\file11.xls” exist only in the second file managing table 24. Accordingly, it is determined that the file “file10.doc” and the file “file11.xls” are the newly added file.

When the difference file is detected by the difference file detecting process (YES in Step S104), the CPU 11 sequentially reads the managing information of the detected difference file to perform the process of updating the document managing table 25 (Step S105 to Step S112). The document managing table 25 updating process is repeatedly performed until the process is completed for all the difference files detected by the difference file detecting process.

Namely, when the difference file detected by the difference file detecting process exists (YES in Step S104), the CPU 11 reads the managing information of the difference file detected by the difference file detecting process one by one (Step S105). When the CPU 11 reads one difference file, the CPU 11 determines whether the difference file is the updated file (file whose update time is changed) or the newly added file (Step S106).

When the CPU 11 determines that the read difference file is the updated file (YES in Step S106), the CPU 11 performs the process of updating the managing information corresponding to the file in the document managing table 25 (Step S107).

When the CPU 11 determines that the read difference file is not the updated file, i.e. when the CPU 11 determines that the difference file is the newly added file (NO in Step S106), the CPU determines whether the difference file is the file which is stored in the newly produced folder or not (Step S108). In Step S108, whether the folder is the new folder is determined by whether the folder in which the file is stored is the folder in which the color is managed by the color managing table 26. Namely, it is determined that the folder in which the color is set in the color managing table 26 is the already-existing folder.

For the file whose pass is “C:\folder3\file10.doc”, the color is already allocated to the folder of “C:\folder3” in the color managing table shown in FIG. 10. In this case, it is determined that the folder of “C:\folder3” is not the new folder. On the other hand, for the file whose pass is “C:\folder4\file11.xls”, the color is not already allocated to the folder of “C:\folder4” in the color managing table shown in FIG. 10. In this case, it is determined that the folder of “C:\folder4” is the new folder.

When the CPU 11 determines that the folder is the new folder (YES in Step S108), the CPU 11 generates the color allocated to the new folder (Step S109). For example, the new color which is not allocated to other folder yet is allocated to the new folder. The unique color ID is allocated to the generated color. When the color allocated to the new folder is generated, the CPU 11 adds color information on the new folder to the color managing table 26 (Step S110). In the color information, the color and the color ID correspond to the new folder.

When the CPU 11 adds the color information on the new folder in which the difference file is stored, the CPU 11 performs a new document adding process (Step S112). In the new document adding process, the managing information on the document corresponding to the difference file is added to the document managing table 25.

When the CPU 11 determines that the folder is not the new folder (NO in Step S108), the CPU 11 obtains the color ID allocated by the color managing table 26 to the folder in which the file is stored (Step S111). In this case, the CPU 11 performs the new document adding process in which the managing information on the document corresponding to the difference file is added to the document managing table 25 (Step S112).

In the new document adding process of Steps S111 and S112, referring to the second file managing table 24 and the color managing table 26, the managing information of the document corresponding to the newly added file is generated.

For example, the update time of the difference file is used as the document time in the managing information on the document. The pass of the difference file is used for the file name in the managing information on the document. Unique information newly generated is used as the document ID in the managing information on the document in order to distinguish the document from the already-existing document. The color ID of the color corresponding to the folder stored in the difference file is used as the color ID in the managing information on the document. The header information on the difference file is used as the header information. However, the number of pages in the managing information on the document is left as the blank field, and the status in the managing information on the document is set at “update”. This is because the number of pages in the managing information on the document is confirmed when the image data is generated from the file through the later-mentioned image generating process.

When the difference file is not detected through the difference file detecting process, or when the process is completed to all the difference files detected by the difference file detecting process (NO in Step S104), the CPU 11 stores the information, currently stored in the second file managing table 24 as the start-up file information, in the first file managing table 23 (Step S113). Accordingly, the file information in performing the difference file detecting process (in this time start-up) is stored in the first file managing table 23, which allows the information stored in the first file managing table 23 to be used as the previous file information in the next start-up.

Thus, the managing information on the document corresponding to the updated file and the managing information on the document corresponding to the newly added file are entered in the document managing table 25 while the statuses are set at “update”. In the document whose status is “update”, the status is changed to “completion” by the later-mentioned image generating process, and the number of pages is confirmed.

Then, the process of generating the document image will be described.

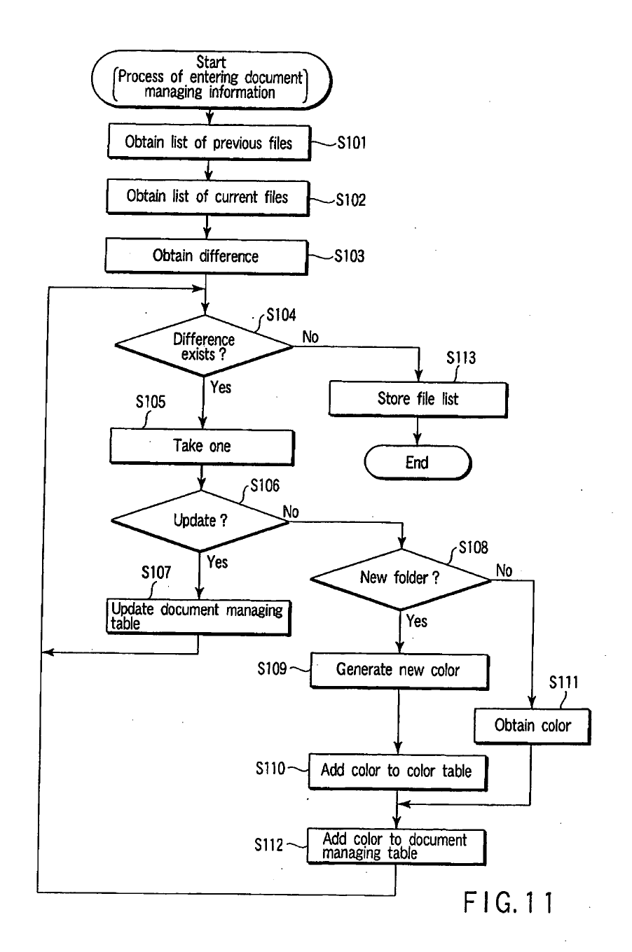

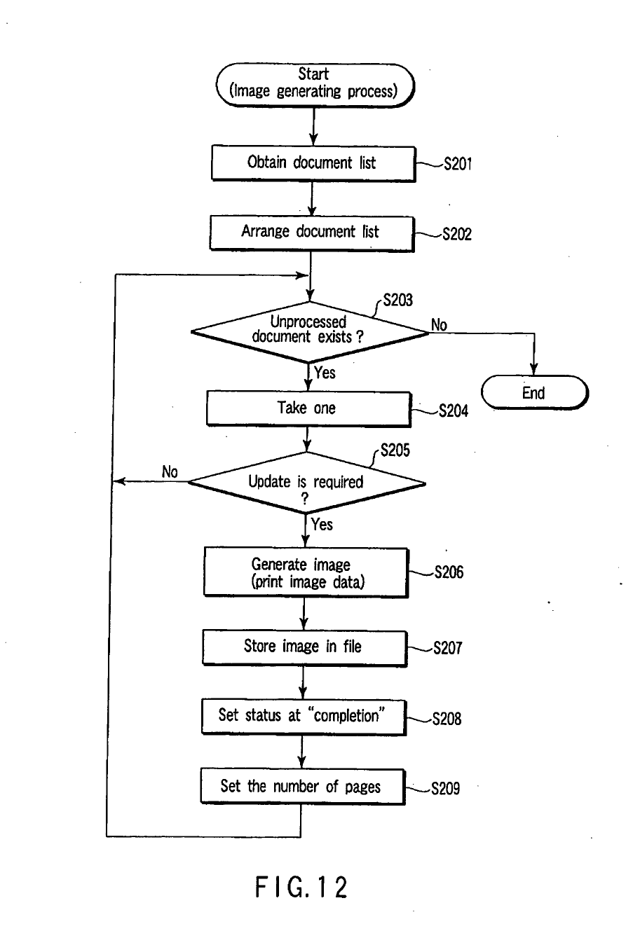

FIG. 12 is a flowchart for explaining the image generating process.

In the document managing information entering process, the pieces of managing information on the document corresponding to the updated file and the newly entered file are entered in the document managing table 25 while the statuses are “update”. In the file whose status is “update”, the display image is not generated. Therefore, for the document whose status is “update”, it is necessary to generate the display image. The process of generating the display image of the document is referred to as image generating process.

When the document managing information entering process is completed, the CPU 11 performs the process of generating the display image. When the image generating process is started up, the CPU 11 reads all the pieces of managing information on the documents from the document managing table 25 (Step S201). When the managing information on the document is read from the document managing table 25, the CPU 11 sorts all the pieces of managing information on the documents based on the document time in the managing information on each document (Step S202). Therefore, in the document managing table 25, all the pieces of managing information on the documents are rearranged in the order of the document time (time-series order). For example, in FIG. 8, the latest three documents are the status of “update”.

When all the pieces of managing information on the documents in the document managing table 25 are sorted based on the document time, the CPU 11 determines whether the document (unprocessed document) to which the image generating process is not performed exists or not (Step S203). When the CPU 11 determines that the unprocessed document exists, the CPU 11 reads the managing information on the unprocessed document in each document (Step S204).

When the CPU 11 reads the managing information on one unprocessed document, the CPU 11 determines whether the status of the managing information on the document read is “update” or not (Step S205). When the CPU 11 determines that the status is “update” (YES in Step S205), the CPU 11 performs the process of generating the display image of the document (Step S206).

In the image generating process, a bitmap image of each page which constitutes the document should be generated as the display image of the document. In the embodiment, the display image data of the document should be produced as print image data. The data of each document is formed by text data or the data in various formats such as the image data.

In the document managing apparatus 1, the document including the pieces of various formats should the managing target. Therefore, in the document managing apparatus 1, the data of each page which constitutes the document is generated as the print image data. Usually, in the pieces of data of various formats used in various application programs, the print image is produced in the application program. For example, when the document is the text data, the display image of the document is generated as the print image by the application program of a word processor.

When the display image data is generated by the image generating process, the CPU 11 stores the image of each page (display image data of each page) which constitutes the document in the form of the image data file in the HDD 15 (Step S207). Therefore, the image data file of the number of the pages of the document is stored in the HDD 15. When the image data file of each page of the document is stored in the HDD 15, the CPU 11 changes the status to “completion” in the managing information on the document in the document managing table 25 (Step S208). The CPU 11 specifies the number of pages from the number of files generated as the image data, and the CPU 11 sets the number of pages as the managing information on the document in the document managing table 25 (Step S209).

When the unprocessed document becomes nonexistent, i.e. when the statuses of all the documents become “completion” in the document managing table 25 (No in Step S203), the CPU 11 ends the image generating process.

As described above, in the embodiment, display image data of each document is generated as one file in each page of the document. The display image data of each document may be generated in any format such as TIF and PDF. A JPEG format is used in the embodiment.

However, in each file of the display image data as the image of each page, the file name should be specified from the document ID and a page number. For example, the file of the display image data is stored in each name of “document ID-page number.jpg”.

In the document managing table 25 shown in FIG. 8, the document of “C:\folder4\file11.xls” is formed by the images of three pages. In this case, in the process of generating the display image for the document of “C:\folder4\file11.xls”, the pieces of display image data of three pages (three image data files in JPEG format) are generated.

As shown in FIG. 8, the document ID is “1011” in the document of “C:\folder4\file11.xls”. Therefore, the three files of “1011-001.jpg”, “1011-002.jpg”, and “1011-003.jpg” are generated as the display image data of the document “C:\folder4\file11.xls”.

In the managing information on the document whose document ID in document managing table 25 shown in FIG. 8 is “1011”, the status is set at “completion”, and the number of pages is set at “three” as shown in FIG. 9. FIG. 9 shows an example of the document managing table 25 when the image generating process is completed for the document managing table 25 shown in FIG. 8.

It is possible that the image generating process is performed in parallel with another process. Namely, it is possible that the image generating process is performed in the background of another process. For example, in the case where there are many documents whose statuses are “update”, or in the case where the number of pages of the document whose status is “update” is large, there is a possibility that it takes a long time to perform the image generating process. Therefore, even if the image generating process is being performed, it is also possible that the CPU 11 performs the later-mentioned process of displaying the document searching screen 40.

Then, the process of displaying the document searching screen (document searching display window) 40 will be described.

FIG. 13 is a flowchart for explaining a display process of the document searching screen 40.

When the document searching screen 40 is displayed (started up), the CPU 11 reads the pieces of managing information of all the documents stored in the document managing table 25 (Step S301). When the CPU 11 reads the pieces of managing information of all the documents stored in the document managing table 25, the CPU 11 arranges the pieces of managing information of all the documents read in the order of the latest document time (time-series order) (Step S302).

After the CPU 11 arranges the pieces of managing information of all the documents read in the time-series order, the CPU 11 reserves a storage area of the current document (display document) on the RAM 12. An information which indicates the currently displayed document is stored in the storage area of the current document. After the storage area of the current document is reserved, the CPU 11 sets the information which indicates the latest document in the storage area of the current document (Step S303). At this point, “order” stored as the managing information on the document in the document managing table 25 should be set as the information which indicates the current document at the storage area of the current document. Namely, the CPU 11 displays the currently displayed document (current document) in the “order” given to each document.

Further, the CPU 11 reserves a storage area of the current page (display page) on the RAM 12. An information which indicates the number of pages of the currently displayed document is stored in the storage area of the current page. After the storage area of the current page is reserved, the CPU 11 sets the information which indicates the representative page (first page in the embodiment) of the document in the storage area of the current page (Step S304). At this point, the number of pages should be set as the information which indicates the current document at the storage area of the current page.

Namely, the CPU 11 displays the representative page (first page) of the latest document as the initial display image. Therefore, the CPU 11 sets the current document at “1”, and sets the current page at “1”. When the CPU 11 sets the current document at “1”, and sets the current page at “1”, the CPU 11 obtains the display image data file of the page (the “1”-st page image in the document whose order is “1”) (Step S305).

In the image obtaining process, the image data file of the page to be displayed referring to the document managing table 25 is specified. Namely, the CPU 11 refers to the document managing table 25 to obtain the document ID corresponding to “order” (“1” in this case) set at the current document. After the CPU 11 obtains the document ID of the current document, the CPU 11 specifies the image data file including the document ID and the page number of the current document from “page number” (“1” in this case) set at the current page.

For example, in the document managing table 25 shown in FIG. 9, the document ID whose order is “1” is “1011”. The image file of the first page of the document ID “1011” is stored in the name of “1011-001.jpg”. Accordingly, in the case where the current document is set at “1” and the current page is set at “1”, the CPU 11 refers to the document managing table 25 shown in FIG. 9 to specify “1011-001.jpg” as the image data file.

After the image data file is obtained by the image obtaining process, the CPU 11 displays the image data of the file in the image display area 41 of the document searching screen 40 (Step S306). After the obtained image data of the file is displayed in the image display area 41, the CPU 11 performs a document map generating process (Step S307). In the document map generating process, the document map 42 showing all the documents in the time-series order is generated. The document map generating process will be described later.

After the document map 42 is created by the document map generating process, the CPU 11 displays the generated document map 42 in a predetermined display area in the document searching screen 40 (Step S308). When the document map 42 is displayed in the document searching screen 40, the CPU 11 specifies the position of the current document in the document map 42 (Step S309). After the position of the current document is specified, the CPU 11 displays the arrow 43 which indicates the position of the current document on the document map 42 (Step S310).

The initial screen is displayed as the document searching screen 40 in the display window on the display device 17 by the document searching screen displaying process.

Then, the document map generating process will be described.

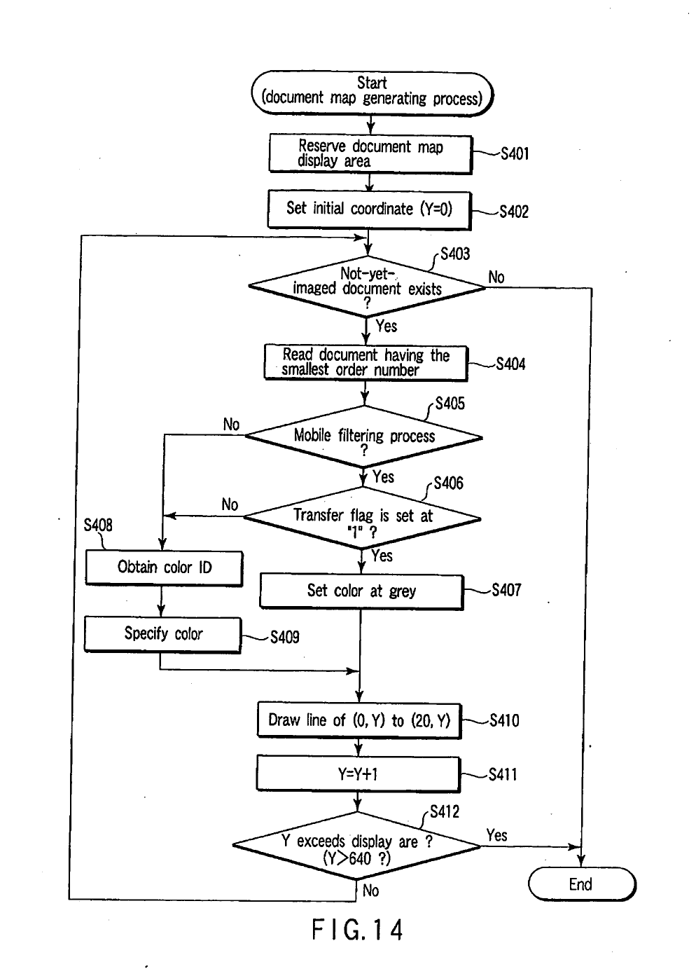

FIG. 14 is a flowchart for explaining the document map generating process.

When the process of generating the document map 42 is started, the CPU 11 reserves the display area to display the document map 42 in the document searching screen 40 (Step S401). The display area of the document map 42 should previously be set. In Step S401, the CPU 11 should display the reserved display area of the document map 42 in the color such as white as an initial value.

For example, as shown in FIG. 3, the display area of the document map 42 is set at the area having the size of a 20-pixel width and a 640-pixel height on the right end of the document searching screen 40. Assuming that the rectangle area is shown by coordinates (X,Y) of (0,0), (20,0), (0,640), and (20,640) as shown in FIG. 3, the display area of the document map 42 will be described.

After the display area of the document map 42 is reserved in the document searching screen 40, the CPU 11 sets an initial coordinate where imaging is started (Step S402). In this case, the initial coordinate is set at the uppermost end in the display area of the document map 42, and a Y-coordinate is set at “0” (Y=0).

After setting the initial coordinate, the CPU 11 reads the managing information on the document from the document managing table 25 in the order in which “order” is increased. Namely, the CPU 11 determines whether the document (not-yet-imaged document) in which the bar is not imaged in the display area of the document map 42 exists in the document managing table 25 or not. When the CPU 11 determines that the not-yet-imaged document exists in the document managing table 25 (Step S403), the CPU 11 reads the managing information on the document having the smallest “order” number in the not-yet-imaged documents (Step S404).

After the managing information on the document, the CPU 11 determines whether the process is the mobile filtering process or not (Step S405). Specifically, the CPU 11 determines whether the currently performed process is the process which is performed by inputting the mobile filter key 17a or not. When the CPU 11 determines that the process is the mobile filtering process (YES in Step S405), the CPU 11 determines whether the transfer flag is set at “1” or not in the document managing table 25 corresponding to the document (Step S406). When the CPU 11 determines that the transfer flag is set at “1” (YES in Step S407), the CPU 11 obtains the color ID which indicates grey to set the color of the document bar (line) displayed in the document map 42 at grey (Step S408).

When the CPU 11 determines that the process is not the mobile filtering process (NO in Step S405), or when the CPU 11 determines that the transfer flag is not set at “1” (NO in Step S406), the CPU 11 specifies the color ID allocated to the read document (Step S408). When the color ID of the document is specified, the CPU 11 refers to the color managing table 26 to confirm the actual color corresponding to the color ID of the document (Step S409). The confirmed color becomes the color imaging the bar which indicates the document in the document map 42 by performing the process of Step S407 or S409.

After the color of imaging bar which indicates the document is specified, the CPU 11 images the bar (line) which indicates the document with the confirmed color at the current coordinate in the display area of the document map 42 (Step S410). The bar which indicates each document should be the line having the width (height) of one pixel in the Y-direction. In this case, for the first document, the bar having the width (height) of one pixel at the Y-initial coordinate ((0,Y) to (20,Y)) is imaged in the display area of the document map 42.

After the bar which indicates the document is imaged, the CPU 11 increments the coordinate in the Y-direction by one pixel by setting “Y=Y+1” (Step S411). When the CPU 11 increments the coordinate in the Y-direction by one pixel, the CPU 11 determines whether the coordinate in the Y-direction exceeds the display area of the document map 42 or not. When the CPU 11 determines that the coordinate in the Y-direction exceeds the display area of the document map 42 (YES in Step S412), the CPU 11 ends the process of generating the document map 42.

When the CPU 11 determines that the coordinate in the Y-direction does not exceed the display area of the document map 42 (NO in Step S412), the CPU 11 returns to Step S403. The CPU 11 repeats Steps S403 to S412 until the not-yet-imaged document does not exist in the display area of the document map 42. Namely, the processes of Steps S403 to S412 are repeatedly performed to all the documents managed by the document managing table 25.

The document map 42, in which the bar that indicates each document is displayed in the color corresponding to each document while stacked in the time-series order, is generated by the above-described processes.

Then, the document searching process will be described.

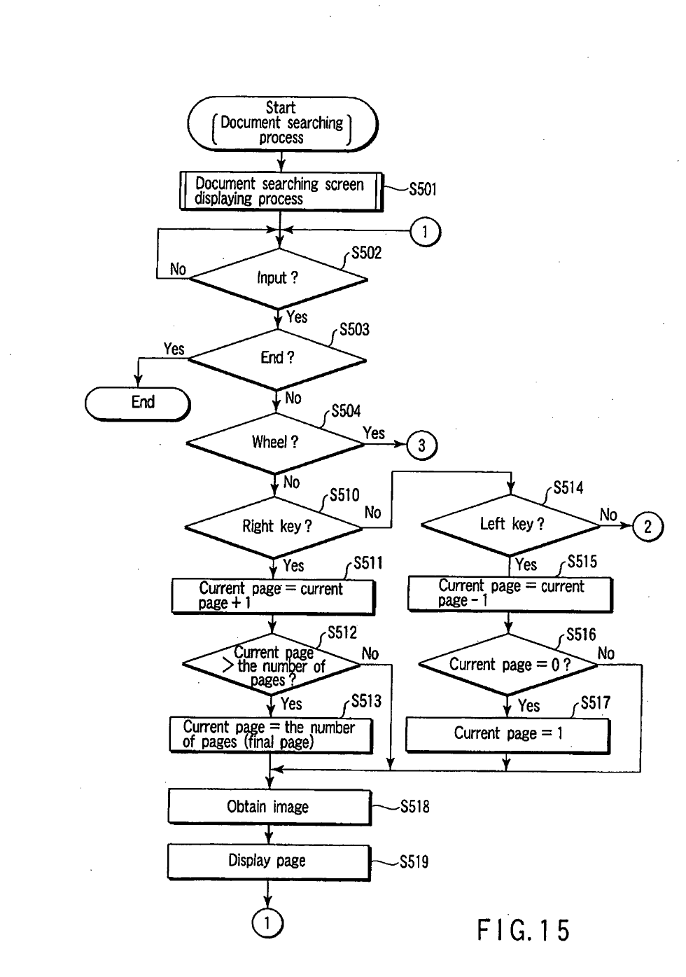

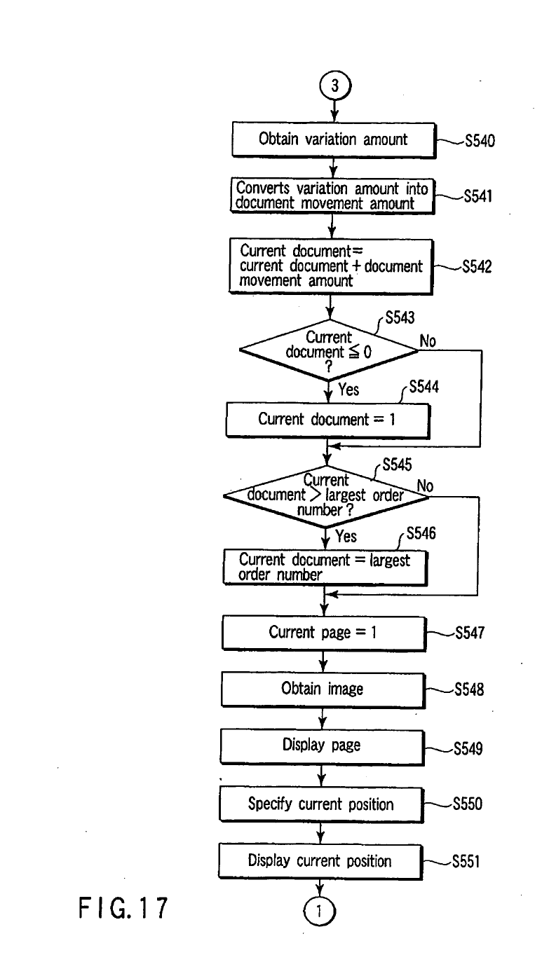

FIGS. 15, 16, and 17 are flowcharts for explaining the document searching process.

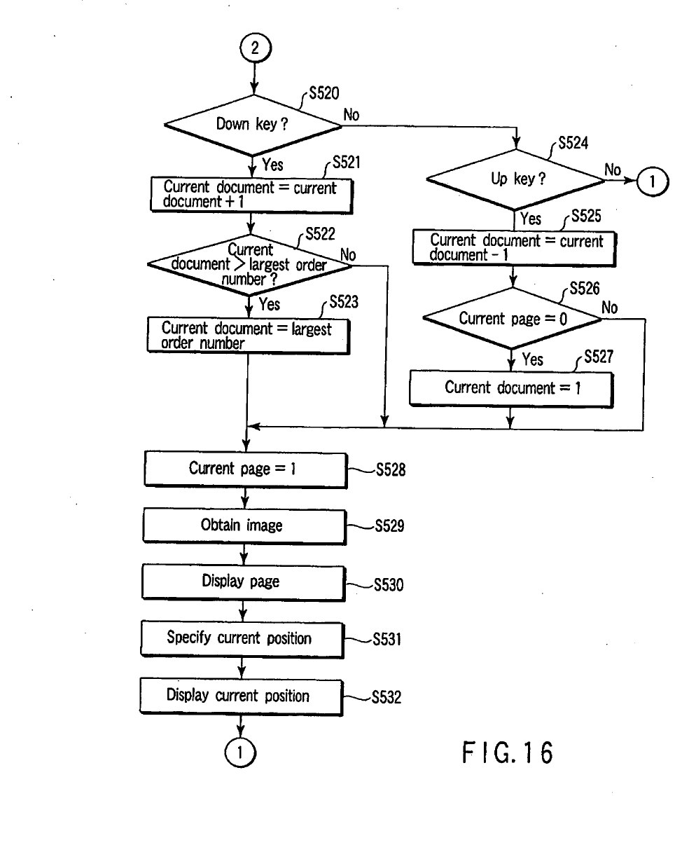

At first the document searching screen 40 should be displayed on the display device 17 by the process of displaying the document searching screen. The first page image of the new document having the latest document time is displayed in the document searching screen 40 (Step S501). Because the process in Step S501 is the same as the one shown in FIG. 16, the description and the flowchart of the sub flow will not be described.

In such a state, the CPU 11 waits for the user's input with the mouse 19 or the keyboard 21 (Step S502). Namely, the CPU 11 detects the presence or absence of the input to the mouse 19 or the keyboard 21. In the input to the wheel 34 of the mouse 19, the rotating amount of the wheel 34 in a predetermined time is inputted as a variation amount. In the input to each key of the keyboard 21 or the right and left buttons 32 and 33 of the mouse 19, the CPU 11 detects which key is inputted.

When the CPU 11 detects the input to the mouse 19 or the keyboard 21 (YES in Step 502), the CPU 11 determines whether contents of the inputted direction are an end direction or not (Step S503). When the CPU 11 determines that the contents of the inputted direction are the end direction (YES in Step S503), the CPU 11 turns off the document searching screen 40 and ends the process.

When the CPU 11 determines that the contents of the inputted direction are not the end direction (NO in Step S503), the CPU 11 determines whether the contents of the inputted direction are the input to the wheel 34 of the mouse 19 or not (Step S504).

When the CPU 11 determines that the contents of the inputted direction are not the input to the wheel 34 of the mouse 19 (YES in Step S504), the CPU 11 determines whether the contents of the inputted direction are the input to the right key giving the direction of the rightward movement (Step S510), whether the contents of the inputted direction are the input to the left key giving the direction of the leftward movement (Step S514), whether the contents of the inputted direction are the input to the down key giving the direction of the downward movement (Step S521), and whether the contents of the inputted direction are the input to the up key giving the direction of the upward movement (Step S525). When the keys except for the right key, the left key, the down key, and the up key are inputted, the CPU 11 returns to Step S502, and the CPU waits for the input again.

When the CPU 11 determines that the input is the right key (YES in Step S510), the CPU 11 increments the current page by one to set at “current page=current page+1” (Step S511). In this case, the CPU 11 obtains the number of pages of the current document from the document managing table 25, and the CPU 11 confirms whether the current page set in Step S511 exceeds the number of pages of the current document (Step S512). When the CPU 11 determines that the current page set in Step S511 exceeds the number of pages of the current document, the CPU 11 sets the current page at the number of pages of the current document, i.e. the final page of the current document (Step S513).

When the CPU 11 determines that the input is the left key (YES in Step 5514), the CPU 11 decrements the current page by one to set at “current page=current page−1” (Step S515). In this case, the CPU 11 confirms whether the current page to be displayed is “0” or not (Step S516). When the CPU 11 determines that the current page set in Step S515 is “0”, the CPU 11 sets the current page at “1”, i.e. the first page of the current document (Step S517).

When the current page is changed through Steps S510 to S517, the CPU 11 obtains the document ID of the current document based on the corresponding relationship between “order” and “document ID” in the document managing table 25. When the document ID of the current document is obtained, the CPU 11 obtains the image file of the page by the document ID and the current page of the current document (Step S518). After the CPU obtains the image file of the page, the CPU 11 displays the image of the page in the image display area 41 of the document searching screen 40 (Step S519).

When the CPU 11 determines that the input is the down key (YES in Step S520), the CPU 11 increments the current document by one to set at “current document=current document+1” (Step S521). In this case, the CPU 11 obtains the largest order number (“order” of the document having the oldest document time) from the document managing table 25, and the CPU 11 confirms whether the current document set in Step S521 exceeds the largest order (Step S522). When the CPU 11 determines that the current document set in Step S521 exceeds the largest order, the CPU 11 sets the current document at the largest order number, i.e. the document having the oldest document time (Step S523).

When the CPU 11 determines that the input is the up key (YES in Step S524), the CPU 11 decrements the current document by one to set at “current document=current document−1” (Step S525). In this case, the CPU 11 confirms whether the current document set in Step S526 is “0” or not (Step S526). When the CPU 11 determines that the current document set in Step S525 is “0”, the CPU 11 sets the current document at “1”, i.e. the CPU sets the current document at the document having the latest document time (Step S527).

When the current document is changed through Steps S520 to S527, the CPU 11 sets the current page at “1” as the representative page of each document (Step S519). Therefore, when the current document and the current page are set, the CPU 11 obtains the document ID of the current document based on the corresponding relationship between “order” and “document ID” in the document managing table 25. When the document ID of the current document is obtained, the CPU 11 obtains the image file of the page by the document ID and the current page of the current document (Step S529). After the CPU 11 obtains the image file of the page, the CPU 11 displays the image of the page in the image display area 41 of the document searching screen 40 (Step S530).

Further, the CPU 11 specifies the position of the current document in the document map 42 in the document searching screen 40 (Step S531). When the position of the current document is specified, the CPU 11 displays the arrow 43 which indicates the position of the current document in the document map 42 (Step S532). It is also possible that the processes of Steps S531 and S532 are performed in parallel with the processes of Steps S528 to S530.

When the CPU 11 determines that the input to the wheel 34 of the mouse 19 exists (YES in Step S504), the CPU 11 obtains the rotating amount of the wheel 34 in the predetermined time as the variation amount (Step S541). The mouse driver 18 detects the rotating amount of the wheel 34. The mouse driver 18 informs the CPU 11 of the detected rotating mount of the wheel 34. Therefore, the CPU 11 is configured to obtain the rotating amount of the wheel 34 in the predetermined time as the variation amount.

After the CPU 11 obtains the variation amount, the CPU 11 converts the obtained variation amount into a document movement amount. (Step S504). The document movement amount shall mean the number of documents which are changed in the display (the number of documents moved). The document movement amount should indicate the direction of the document movement. The relationship among the rotating amount of the wheel 34, the variation amount, and the document movement amount will be described in detail later.

In this case, the document movement amount is set at a positive value when the wheel 34 is rotated in a normal direction, and the documents are moved in the order of “order” of the documents in the movement direction. The document movement amount is set at a negative value when the wheel 34 is rotated in a reverse direction, and the documents are moved in the reversal order of “order” of the documents in the movement direction.

When the variation amount based on the rotating amount inputted to the wheel 34 is converted into the document movement amount (Step S541), the CPU 11 sets the current document at the document (current document=current document+document movement amount) which is moved by the document movement amount (Step S542). In this case, the CPU 11 confirms whether the current document set in Step S542 is not more than “0” or not (Step S543). When the CPU 11 determines that the current document set in Step S542 is “0” or less (YES in Step S543), the CPU 11 sets the current document at “1”, i.e. at the document having the latest document time (Step S544).

When the CPU 11 determines that the current document set in Step S542 is more than “0” (NO in Step S543), the CPU 11 further obtains the largest order number (“order” of the document having the oldest document time) from the document managing table 25, and the CPU 11 confirms whether the current document set in Step S542 exceeds the largest order (Step S545). When the CPU 11 determines that the current document set in Step S542 exceeds the largest order (YES in Step S545), the CPU 11 sets the current document at the largest order number, i.e. the document having the oldest document time (Step S546).

When the current document is changed through Steps S540 to S546, the CPU 11 sets the current page at “1” as the representative page of each document (Step S547). Therefore, when the current document and the current page are set, the CPU 11 obtains the document ID of the current document based on the corresponding relationship between “order” and “document ID” in the document managing table 25. When the document ID of the current document is obtained, the CPU 11 obtains the image file of the page by the document ID and the current page of the current document (Step S548). After the CPU obtains the image file of the page, the CPU 11 displays the image of the page in the image display area 41 of the document searching screen 40 (Step S549).

Further, the CPU 11 specifies the position of the current document in the document map 42 in the document searching screen 40 (Step S550). When the position of the current document is specified, the CPU 11 displays the arrow 43 which indicates the position of the current document in the document map 42 (Step S551). It is also possible that the processes of Steps S550 and S551 are performed in parallel with the processes of Steps S547 to S549.

In the above processes, the variation amount according to the rotating amount of the mouse wheel inputted by the user is converted into the document movement amount to change the document which displays the first-page image on the display device according to the document amount movement, which allows the document that displays the first-page image to be efficiently S changed by rotating the wheel 34 of the mouse 19. As a result, the user can efficiently search the document managed by the document managing apparatus 1, and easily find out the desired document.

Then, the relationship among the rotating amount of the wheel 34 of the mouse 19, the variation amount, and the document movement amount will be described.

The relationship between the rotating amount of the wheel 34 of the mouse 19 and the document movement amount obtained by the CPU 11 is previously set by the setting information and the like. The relationship between the variation amount and the document movement amount, which are obtained by the CPU 11, is also previously set by the setting information and the like. The user can change the pieces of setting information to an arbitrary value.

For example it is assumed that the variation amount is set at “2880” for one rotation of the wheel 34 of the mouse 19. In this case, when the number of documents moved is set at “1” for the variation amount of “1”, the 2880 documents are moved with respect to the one rotation of the wheel 34. This means that, in the image (image of the representative page of each document) displayed in the image display area 41, the images of 2880 documents are changed by one rotation of the wheel 34.

In this case, because the movement amount of the document displayed in the image display area 41 is too large, the user hardly searches the desired document. Therefore, the number of documents moved is set at “1” for the variation amount of “120”. Then, the 24 documents are moved with respect to one rotation of the wheel 34, so that the user can easily search the desired document.

Then, the document transfer process will be described. In the document transfer process, the file of the document which matches a previously set rule (condition) among the documents stored in the document managing table 25 and the document managing information stored in the document managing table 25 are transferred to the mobile equipment 2. In the embodiment, it is assumed that the previously set rule is the latest 100 documents in the time-series order. It is possible that the user changes the setting of the document transferred to the mobile equipment 2 on the document searching screen 40. In the setting of the document transferred to the mobile equipment 2, it is possible that the setting is performed in each folder, or that the setting is performed in the same file extensions. It is also possible that the documents produced by the user are set at the document transferred to the mobile equipment 2.

In the embodiment, the document transfer process is automatically performed when the connection of the mobile equipment 2 to the network interface 14 is detected. It is also possible that the document transfer is performed at the time when the user gives a direction on the document searching screen 40 to the mouse 19 or the keyboard 21.

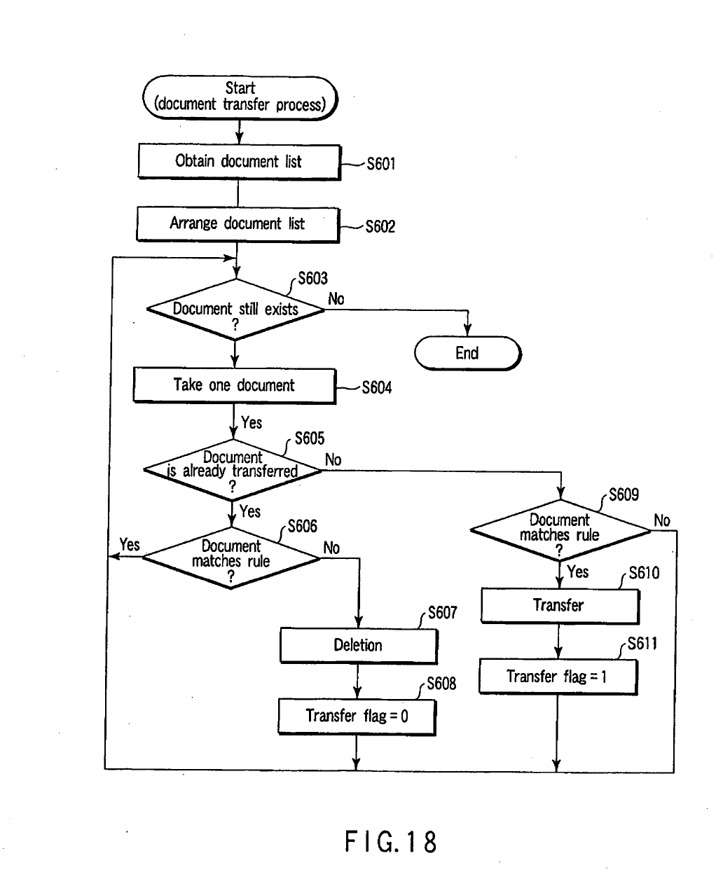

FIG. 18 is a flowchart for explaining the document transfer process.

The CPU 11 reads the pieces of managing information of all the documents stored in the document managing table 25 (Step S601). When managing information of all the documents stored in the document managing table 25 is read, the CPU 11 arranges the pieces of managing information of all the documents read in the time-series order (Step S602).

When managing information of all the documents is arranged in the time-series order, the CPU 11 determines whether the unprocessed document still exists or not (Step S603). When the CPU 11 determines that the unprocessed document still exists, the CPU 11 takes one document (Step S604), and the CPU 11 determines whether the document is already transferred to the mobile equipment 2 or not (Step S605). Specifically, the CPU 11 determines whether the transfer flag related to the document ID of the document is set at “1” or not.

When the CPU 11 determines that the document is already transferred to the mobile equipment 2, i.e. when the CPU 11 determines that the transfer flag is set at “1” (YES in Step S605), the CPU 11 determines whether the document matches the predetermined rule or not (Step S606). Specifically, the CPU 11 determines whether the document matches the latest 100 documents in the time-series order or not. When the CPU 11 determines that the document matches the rule (YES in Step S606), the CPU 11 performs the process of Step S603. When the CPU 11 determines that the document does not match the rule (NO in Step S606), i.e. when the CPU 11 determines that the document does not match the latest 100 documents in the time-series order, the CPU 11 performs a deleting process (Step S607). Specifically, in the deleting process, the CPU 11 outputs a deleting command to the mobile equipment 2 through the network interface 14. The deleting command is one which deletes the document transferred to the mobile equipment 2 and the managing information of the document. The process in the mobile equipment 2 in receiving the deleting command will be described later. When the CPU 11 outputs the deleting command to the mobile equipment 2, the CPU 11 sets the transfer flag related to the document ID of the document at “0”. Then, the CPU 11 performs the process of Step S603.

When the CPU 11 determines that the document is not already transferred to the mobile equipment 2 (NO in Step S605), the CPU 11 determines whether the document matches the predetermined rule or not (Step S609). Specifically, the CPU 11 determines whether the document matches the latest 100 documents in the time-series order or not. When the CPU 11 determines that the document matches the rule (YES in Step S609), the CPU 11 performs the transfer process (Step S610). Specifically, in the transfer process, the CPU 11 outputs the document and the managing information data of the document to the mobile equipment 2 through the network interface 14 after a transfer command is outputted. The process in the mobile equipment 2 in receiving the transfer command will be described later. After the CPU 11 outputs the document and the managing information data to the mobile equipment 2, the CPU 11 sets the transfer flag related to the document ID of the document at “1”. Then, the CPU 11 performs the process of Step S603. When the CPU 11 determines that the document does not match the rule (NO in Step S609), the CPU 11 performs the process of Step S603.

When the CPU 11 determines that the unprocessed document does not exist in Step S603, the CPU 11 ends the process.

Then, the document synchronizing process of the mobile equipment 2 will be described. The document synchronizing process is performed when the mobile equipment 2 receives the deleting command, the transfer command, the document, and the managing information data of the document from the document managing apparatus 1 through the network interface 54.

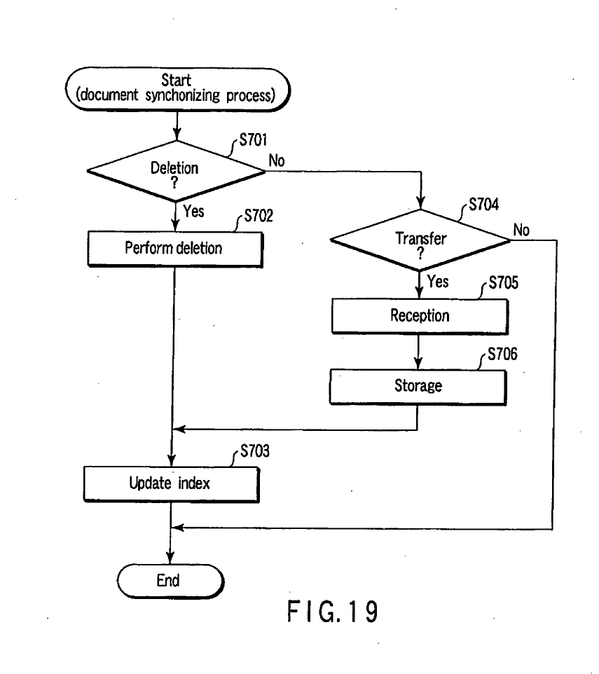

FIG. 19 is a flowchart for explaining the document synchronizing process.

The CPU 51 determines whether the received data is the deleting command data or not (Step S701). When the CPU 51 determines that the received data is the deleting command data (NO in Step S701), the CPU 51 performs the deletion (Step S702). Namely, the CPU 51 deletes the document and the managing information of the document, which are indicated by the deleting command, from the SD card 58a through the SD card interface 58. Then, the CPU 51 updates an index in the SD card 58a (Step S703).

When the CPU 51 determines that the received data is not the deleting command data (NO in Step S701), the CPU 51 determines whether the received data is transfer command data or not (Step S704). When the CPU 51 determines that the received data is transfer command data (YES in Step S704), the CPU 51 receives the document and the managing information data of the document (Step S705). The CPU 51 stores the received data in the SD card 58a through the SD card interface 58 (Step S706). Then, the CPU 51 updates the index in the SD card 58a (Step S703).

When the CPU 51 receives the pieces of command data except for the deleting command and the transfer command (NO in Step S701 and NO in Step S704), the CPU 51 performs the process according to the received command. Because the process is not directly related to the invention, the illustration and description will be omitted.

The document transfer process is performed in the document managing apparatus 1, and the document synchronizing process is performed in the mobile equipment 2. Therefore, the document managing apparatus 1 transfers part of the documents which match the predetermined rule (condition) among the managed documents to the mobile equipment 2. The document managing apparatus 1 causes the mobile equipment 2 to delete the document which becomes incompatible with the predetermined rule in the transferred documents. The document managing apparatus 1 can change the setting of the transfer flag of the document managing table 25 based on the transfer and deletion of the document.

Accordingly, when the document managing apparatus 1 transfers a part of managed documents to the mobile equipment, the document managing apparatus 1 can also synchronize the transferred document with the document stored in the SD card 58a of the mobile equipment 2 by utilizing the transfer flag of the document managing table 25.

Then, the mobile filtering process in the document managing apparatus 1 will be described.

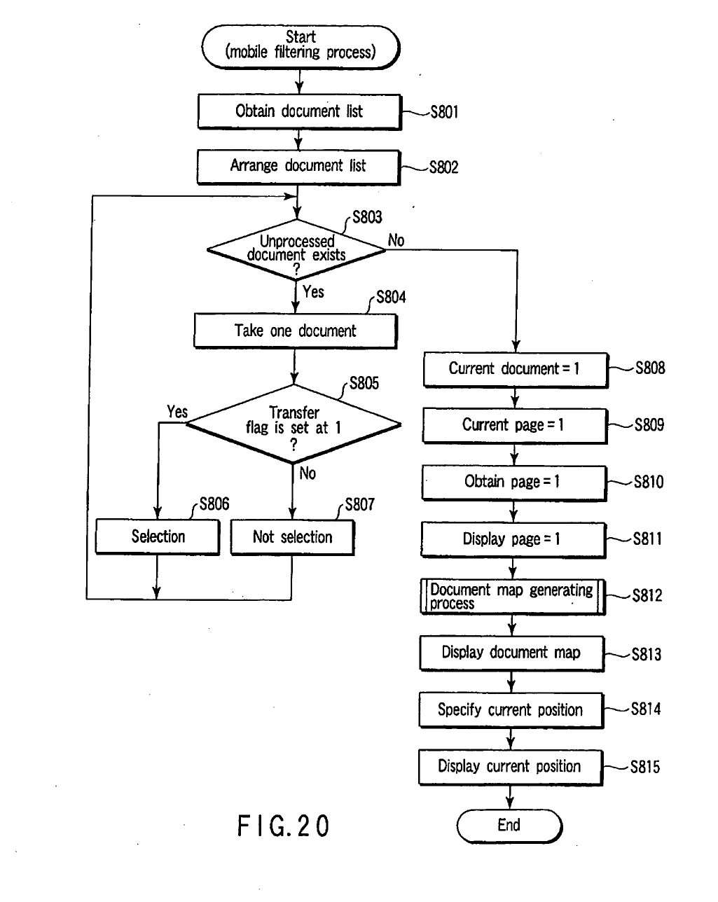

FIG. 20 is a flowchart for explaining the mobile filtering process.

The mobile filtering process is started, when the user inputs the mobile filter key 17a in the document searching screen 40 displayed on the display device 17 using the mouse 19 or the key in the keyboard 21.

When the user inputs the mobile filter key 17a, the CPU 11 reads the pieces of managing information of all the documents stored in the document managing table 25 (Step S801). When managing information of all the documents stored in the document managing table 25 is read, the CPU 11 determines whether the document (unprocessed document) to which the mobile filtering process is not performed exists or not (Step S803). When the CPU 11 determines that the document to which the mobile filtering process is not performed exists, the CPU 11 reads the managing information of the unprocessed document one by one (Step S804).

When the CPU reads one piece of managing information of the unprocessed document, the CPU 11 determines whether the transfer flag of the document in the document managing table 25 is set at “1” or not (Step S805). When the CPU 11 determines that the transfer flag is set at “1”, the CPU 11 selects the document (Step S806). When the CPU 11 determines NO in Step 805, i.e. when the CPU 11 determines that the transfer flag is set at “0”, the CPU 11 does not select the document (Step S807). After the process of determining whether the document is selected or not, the CPU 11 returns to the process of Step S803.

Thus, the process of determining whether the document is selected or not is performed in the time-series order for all the documents stored in the document managing table 25 by performing the processes of Steps S803 to S807. Namely, whether the document is the document transferred to the mobile equipment 2 or not is selected. The filtered documents in the above manner are arranged in the time-series order in a predetermined area of a RAM 12.

When the CPU 11 determines that the document to which the mobile filtering process is not performed does not exist (NO in Step S803), the CPU 11 sets the current document at 1 (Step S808), and sets the current page at 1 (Step S809). Then, the CPU 11 obtains the image of the page (Step S810), and displays the page in the document searching screen 40 (Step S811). Then, the CPU 11 performs the process of generating the document map (Step S812), displays the document map (Step S813), specifies the current position (Step S814), and displays the current position (Step S815). Then, the CPU ends the process. The processes of Steps S808 to S815 are similar to the processes of Steps S303 to S310 described above referring to FIG. 13, so that the detail description will not be repeated.

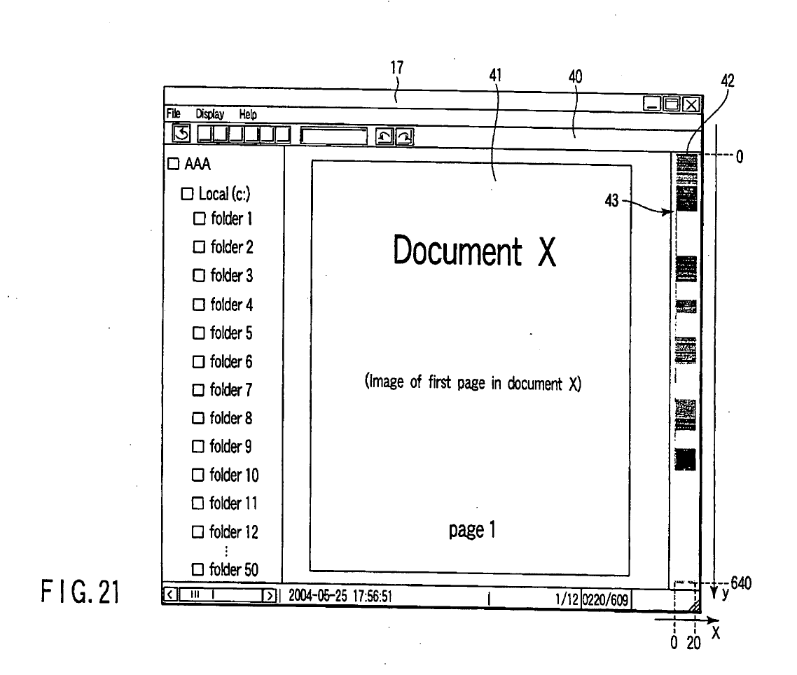

FIG. 21 shows the document searching screen 40 displayed on the display device 17 when the mobile filtering process is performed by pressing down the mobile filter key 17a. When compared with the normal document searching process described in FIG. 3, the display of the document map 42 is changed. Namely, all the documents which are not transferred to the mobile equipment 2 are shown in grey. In the embodiment, the documents except for the 100 documents which are transferred to the mobile equipment 2 are shown in grey (documents which should be shown in grey is shown in white in FIG. 21). Therefore, the user can intuitively, visually recognize the documents which are transferred to the mobile equipment 2 and the documents which are not transferred to the mobile equipment 2 from the display of the document map 42.

Then, in order that the user changes the first-page display image of the document displayed in the document searching screen 40 to the first-page display image of the next document, the user operates the wheel 234 of the mouse 19 or the up and down keys of the keyboard 21. When the CPU 11 receives the direction of the operation, the CPU 11 selects the preceding document from the documents arranged in the predetermined area of the RAM 12 in the time-series order when the mobile filtering process is performed. The CPU 11 displays the image of one page of the selected document in the document searching screen 40. Because the process of searching the document only from the documents selected through the mobile filtering process is similar to the processes described in FIGS. 15 to 17, the description and the illustration will not be repeated.

When the user operates the mouse 19 or the up and down keys of the keyboard 21 to change the image displayed in the document searching screen 40, only the document transferred to the mobile equipment 2 among the documents managed by the document managing table 25 is displayed in the document searching screen 40. Thus, the user can search the document only from the documents transferred to the mobile equipment 2 by causing the document managing apparatus 1 to perform the mobile filtering process.

Accordingly, the document managing apparatus 1 can reproduce the same search state as for the mobile equipment 2.

The same image is displayed in both the document map of the document managing apparatus 1 and the document map of the mobile equipment 2 except for the part shown in grey in the document map 42 of the document managing apparatus 1. Therefore, user can easily find out the target document when the user searches the document based on the user's memory that the target document is stored near here.

In the embodiment, the function of realizing the invention is previously recorded in the apparatus. However, the invention is not limited to the embodiment. It is also possible that the same function is downloaded from the network to the apparatus, or that the same function is stored in a recording medium and installed in the apparatus. Any recording medium can be used, as long as the program can be stored in the recording medium such as a CD-ROM and read by the apparatus. It is possible that the function obtained by the previous installation and download is realized in association with an operating system (OS) and the like in the apparatus.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A document managing apparatus comprising:
a display unit;
an operation unit;
an interface which is connected to mobile equipment while data can be transferred;
a file managing information storage unit which stores file managing information on a file of data which constitutes a document, the document being a managing target;
a document managing information storage unit which stores document managing information on a plurality of documents, the plurality of documents being stored in the file managing information storage unit;
a transfer information storage unit which stores transfer information in relation to the document stored in the document managing information storage unit, the transfer information indicating whether the file stored in the file managing information storage unit is transferred to the mobile equipment through the interface according to a condition previously set;
a selection unit which selects only the document transferred to the mobile equipment based on the transfer information stored in the transfer information storage unit when a direction is received from the operation unit; and
a document display unit which displays a document image on the display unit in the particular order according to a direction from the operation unit, the document image being selected by the selection unit.

2. The document managing apparatus according to claim 1, further comprising
a document synchronizing unit which synchronizes the document stored in the document managing information storage unit and the document transferred to the mobile equipment based on the transfer information stored in the transfer information storage unit and the predetermined condition, when the direction to synchronize the document stored in the document managing information storage unit and the document transferred to the mobile equipment is received from the operation unit.

3. The document managing apparatus according to claim 2, wherein
the document synchronizing unit directs the mobile equipment to delete the document which does not match the predetermined condition, when the transfer information which shows that the transfer is performed is stored in the transfer information storage unit.

4. The document managing apparatus according to claim 2, wherein
the document synchronizing unit transfers the document which matches the predetermined condition to the mobile equipment, when the transfer information which shows that the transfer is not performed is stored in the transfer information storage unit.

5. The document managing apparatus according to claim 1, wherein
the predetermined condition is the condition that the predetermined number of documents is selected from the new document when the documents are arranged in the time-series order.

6. The document managing apparatus according to claim 1, wherein
the predetermined condition is the condition that a previously set classification is selected from file classifications of the document.

7. A document managing program which is executed by a computer, the program comprising:
a file managing information storage function of storing file managing information on a file of data which constitutes a document, the document being a managing target;
a document managing information storage function of storing document managing information on a plurality of documents, the plurality of documents being stored in the file managing information storage function;
a transfer information storage function of storing transfer information in relation to the document stored in the document managing information storage function, the transfer information indicating whether the file stored in the file managing information storage function is transferred to a mobile equipment through an interface according to a condition previously set, the interface being connected to the mobile equipment while data can be transferred;
a selection function of selecting only the document transferred to the mobile equipment based on the transfer information stored in the transfer information storage function when a direction is received from an operation unit; and
a document display function of displaying a document image on a display unit in the particular order according to the direction from the operation unit, the document image being selected by the selection function.

8. The document managing program according to claim 7, further comprising
a document synchronizing function of synchronizing the document stored in the document managing information storage function and the document transferred to the mobile equipment based on the transfer information stored in the transfer information storage function and the predetermined condition, when the direction to synchronize the document stored in the document managing information storage function and the document transferred to the mobile equipment is received from the operation unit.

9. The document managing program according to claim 8, wherein
the document synchronizing function causes the mobile equipment to delete the document which does not match the predetermined condition, when the transfer information which shows that the transfer is performed is stored in the transfer information storage function.

10. The document managing program according to claim 8, wherein
the document synchronizing function transfers the document which matches the predetermined condition to the mobile equipment, when the transfer information which shows that the transfer is not performed is stored in the transfer information storage function.

11. The document managing program according to claim 7, wherein
the predetermined condition is the condition that the predetermined number of documents is selected from the new document when the documents are arranged in the time-series order.

12. The document managing program according to claim 7, wherein
the predetermined condition is the condition that a previously set classification is selected from file classifications of the document.

13. A method of searching a document managed by a document managing apparatus, comprising:
managing file managing information on a file of data which constitutes a document, the document being a managing target;
managing document managing information on the plurality of managed documents;
storing transfer information in relation to the managed document on the document managing information, the transfer information indicating whether the managed file is transferred to a mobile equipment through an interface according to a condition previously set, the interface being connected to the mobile equipment while data can be transferred;
receiving a direction from an operation unit;
selecting only the document transferred to the mobile equipment based on the stored transfer information; and
displaying a selected document image on a display unit in the particular order according to the direction from the operation unit.

14. The method according to claim 13, further comprising:
receiving the direction to synchronize the managed document of the document managing information and the document transferred to the mobile equipment; and
synchronizing the managed document of the document managing information and the document transferred to the mobile equipment based on the stored transfer information and the predetermined condition.

15. The method according to claim 14, wherein
the synchronizing is to direct the mobile equipment to delete the document which does not match the predetermined condition, when the transfer information which shows that the transfer is performed is stored.

16. The method according to claim 14, wherein
the synchronizing is to transfer the document which matches the predetermined condition to the mobile equipment, when the transfer information which shows that the transfer is not performed is stored.

17. The method according to claim 13, wherein
the predetermined condition is the condition that the predetermined number of documents is selected from the new document when the documents are arranged in the time-series order.

18. The method according to claim 13, wherein
the predetermined condition is the condition that a previously set classification is selected from file classifications of the document.
